(19) United States
(12) Patent Application Publication
(10) Pub. No.: US 2008/0297475 A1
(43) Pub. Date: Dec. 4, 2008

(54) Input Device Having Multifunctional Keys

(76) Inventors: Tod M. Woolf, Sudbury, MA (US); Andrew S. Marks, Wayland, MA (US)

Correspondence Address: LAHIVE & COCKFIELD, LLP;FLOOR 30, SUITE 3000, ONE POST OFFICE SQUARE, BOSTON, MA, 02109, US

(21) Appl. No.: 11/996,722

(22) PCT Filed: Aug. 1, 2006
(86) PCT No.: PCT/US06/30571

§ 371 Date: Jun. 30, 2008

Related U.S. Application Data
(60) Provisional application No. 60/595,744, filed on Aug. 2, 2005.

(51) Int. Cl. G06F 3/033; G06F 3/02; G06F 3/041

(52) U.S. Cl. 345/163; 345/168; 345/173

(57) ABSTRACT

The invention relates to an input device having multifunctional keys, wherein the different functions are triggered by varying the pressure on the keys or by varying the depth to which the key is depressed or the distance it is moved (see FIG. 3). The input device requires substantially fewer keys than a standard qwerty keyboard to input data and requires less physical space. In certain instances the keyboard can be operated with one hand.

### RELATED APPLICATION INFORMATION

This application claims priority to and the benefit of a United States Provisional Application entitled “Input Device Having Multifunctional Keys”, filed Aug. 2, 2005, Application No. 60/595,744.

### TECHNICAL FIELD OF THE INVENTION

The invention relates to an input device having multifunctional keys, wherein the different functions are triggered by varying the pressure on the keys or by varying the depth to which the key is depressed or the distance it is moved. The input device requires substantially fewer keys than a standard qwerty keyboard to input data and requires less physical space. In certain instances the keyboard can be operated with one hand.

### BACKGROUND OF THE INVENTION

A standard keyboard has keys corresponding to the 26 letters of the alphabet, numbers 0-9, punctuation, and other various commonly used symbols. Including a shift key, a control key and an alt key, the total number of keys is approximately 50. A modern day computer keyboard can contain approximately 100 different key, including function keys, specialized programmable keys and pre-programmed computer function keys. Most of the keys will produce a capital letter or non-alphanumeric character when depressed simultaneously with the shift key. Most of the keys will also produce a second character, modify the font, perform an editing function or even launch a macro when depressed simultaneously with the alt key or control key.

The number of keys in a standard keyboard limits its use to locations and with devices that are sufficiently large to accommodate a size sufficiently large to fit all of the keys without sacrificing the ability of the user to tactilely distinguish the individual keys. The standard keyboard does not lend itself to use in hand-held devices, or other situations where a large keyboard would be awkward or inappropriate.

Other arrangements of keyboards exist beside the standard arrangement. For example, U.S. Pat. No. 4,891,777 to Lapeyre is directed to a single hand keyboard array that provides alphanumeric capabilities from twelve keys. The keyboard is intended to be operated using one hand. The system employs virtual keys that are selected by simultaneous action of two or more individual keys. The apparatus decodes the signals produced by activation of the switches to produce the alphanumeric symbol desired. U.S. Pat. No. 5,087,910 to Guyot-Sionnest pertains to an electronic keyboard for one-hand operation. The keyboard produces alphanumeric and analog characters upon the activation of one or more finger keys and a thumb key. The finger keys can each assume one of three states, and the thumb key can assume five different states. The keys can thereby, in combination, produce 134 different characters.

Another device is described in U.S. Pat. No. 5,543,818 to Scott which relates to a method and apparatus for entering text using an input device having a small number of keys. A display device, connected to a CPU, displays a character selection menu having sixteen groups of characters. An input device which includes four cursor movement keys and four selection keys to choose a desired character. The four cursor movement keys move the cursor on the display from one character group to another. The four selection keys determine which of four characters in a group is desired.

U.S. Pat. No. 4,680,577 to Straayer et al teaches a multipurpose cursor control keyswitch. The switch has an ordinary function of producing an alphanumeric symbol when depressed vertically, and directs cursor movement when horizontal pressure is applied. The Straayer et al keyswitch is not intended to reduce the number of keys and is not designed to facilitate one hand operation.

A multiple switch assembly including a rockable control plate for selectively actuating multiple microswitches is disclosed in U.S. Pat. No. 5,504,286 to Tsai. The assembly is intended to reduce the number of keys on the keyboard of a portable computer by employing rockable keys which can produce two characters without reducing the size of the keys. The keys can be pressed to either one of two sides corresponding to two different characters. The primary reason for reducing the number of keys is to accommodate a cursor movement device.

U.S. Pat. No. 4,769,516 to Allen relates to a finger operated switching apparatus. The keyboard utilizes keys which can produce three different characters. The keyboard is intended to replace a conventional keyboard and requires two hands for use.

U.S. Pat. No. 5,504,286 to Blauer pertains to a keyboard with elongate keys associated with compact switch mechanisms. The keyboard is intended to be used with both hands and is intended for use in a desk-top configuration. The keyboard has a series of keys which produce two or three outputs depending upon how the keys are depressed. U.S. Pat. No. 5,861,823 relates to a data entry device having multifunction keys which each have a central primary numeric character and secondary alphabetic characters, where the numeric character is produced by applying a primarily vertical force to the key and the secondary alphabetic characters are produced by applying additional force in secondary directions.

U.S. Pat. No. 5,841,374 relates to a keyboard having six keys on the face of each keypad portion and a maximum of four keys along each edge, adjacent to the six face keys. Each key can have up to seven functions that are invoked by pressing the key in one of six different directions or pressing down to contact seven different switches underlying the key.

Multifunction keys where different characters are produced based on the number of times a key is depressed within a time interval are also known and are available on cell phones. Each depression of the key within a time interval causes the display to cycle to the next character producible by that particular key. Once the time interval expires, the cursor moves to the next position and depression of a key inputs a character in the adjacent position.

Touchscreens and touchpads are also well known. Touchscreens allow the user to input data by exerting pressure at different positions on the screen. Keyboards can be emulated on touchscreens so that when a position displaying a graphic of a character key is touched, that character key is outputted. Touchpads emulate a mouse, trackball or other such input device by detecting pressure or conductance from a user's finger making contact with the touchpad. Some touchpads can be programmed so that various positions on the touchpad correspond to different input functions and to detect tapping on the pad to mimic the functions of a mouse button. There is even a function on certain touchpads that can be programmed to move a cursor at a speed corresponding to the amount of tactile pressure exerted on the touchpad.

Despite all of the input devices known in the art, none provide multifunctional keys, buttons or other input areas (collectively referred to as “input segments”), wherein the various functions can be controlled without either lifting a finger or stylus off of the input segment, shifting a finger or finger pressure to a different portion of the input segment, or employing a second input segment. It would be highly advantageous to be able to control multiple functions of an input device without having to reposition a finger or stylus.

### SUMMARY OF THE INVENTION

The above-described prior art is rife with problems stemming from the fact that accessing various functions controlled by a multifunctional input segment cannot be achieved without having to reposition one's finger or a stylus on that segment. This often causes unintended input, which requires additional time and physical stress to correct.

For example, the proper functioning of multidirectional multifunctional keys requires that the keys are large enough and spaced far enough apart so that the user can distinguish and perform the different directions functions (i.e., move the finger or shift finger pressure to a different part of the key) without inadvertently triggering an undesired function of that same key or of a neighboring key on the keyboard. This is particularly difficult if the user has larger fingers.

Control of input on multifunctional keys that require repeated depressing within a time interval can be difficult and frustrating. Users of such keys often produce unwanted characters that need to be erased, or inadvertently pass by the desired character in a multifunction cycle of a key requiring the repeated depression of the key within the time interval to recycle to the desired character.

Requiring a second key to be depressed to invoke additional functions is less convenient for the user and, for smaller handheld devices, is cumbersome.

The present invention solves the problem set forth above by providing an input device in communication with a computer, said input device comprising a multifunctional input segment, wherein force of pressure exerted on said multifunctional input segment determines which function is outputted by said computer. The invention reduces repetitive stress, reduces unintended triggering of functions, requires less effort to input data and is more secure than a typical keyboard in that a video of finger movement would not provide full information as to what data was being inputted.

The term “input device” as used herein includes, but is not limited to a keyboard, such as a qwerty or other type of computer keyboard, a chorded keyboard, a keypad, a key-based control panel or another array of control keys; a pointing device, such as a computer mouse, trackball, touchpad, trackpad, joystick, pointing stick, stylus, light pen, or light gun (e.g., Zapper Light Gun (Nintendo Entertainment System)); a cyberglove; a graphical input device, such as a graphics tablet (or digitizing tablet), a touch screen or other touch-sensitive display; a game controller such as a gamepad (or joypad), a paddle, a floor pad or a Power Pad; arrays of control buttons on electronic devices, such as computer peripherals (such as printers, scanners, networking devices, devices bridging the computer to another electronic device) standalone digital devices (such as digital cameras, digital video recorders, digital music players, GPS devices and recorders), televisions, CD players and appliances; control panels in vehicles, including control panels for stereos, radar detectors and GPS devices in vehicles; control panels in flight controllers, etc.

Preferably, the input device is selected from a computer keyboard, a touchpad, a touch screen or a mouse.

The input device may be in communication with the computer via a direct connection (as in when the input device is part of the same electronic device as the computer, a wired connection, a wireless connection, or through the internet, an intranet or other network connection.

As used herein, a computer may be “in communication” with an input device or a multifunctional input segment of said input device if the input is communicated to the computer in such a manner that a processor can carry out the intended function. Such communication may be achieved directly through the device or input segment or indirectly through one or more intermediate devices, computers, detectors, translators, switches or the like.

The term “computer” as used herein, includes any electronic device that comprises a processor, can receive input and generate output based upon said input. This includes, but is not limited to, laptop and desktop computers, cell phones, PDAs, computerized appliances, ATM machines, VCRs, DVD players and recorders, digital music recorders, printers, facsimile machines, smart keyboards, scanners, GPS navigation devices, computers or chips that control vehicle functions, voice prompt systems, weapon system controllers, gaming devices, device-specific and universal remote control units, a device that is a combination of one or more of the foregoing (such as a PDA/cell phone combination), and the like.

The term “multifunctional input segment” as used herein refers to a portion of an input device that controls two or more different functions each leading to a different output. Examples of a multifunctional input segment are a key; a button (including a mouse button); a portion of a touch-sensitive device; a portion of an electronic stylus; a joystick, joypad, wheel or other device wherein directionality controls function; a finger of a motion sensing glove (cyberglove); or a finger, stylus or other pointing device used in conjunction with a video recorder that can detect and distinguish movement or with a motion detector. In the case of a video recorder or a motion detector, the distance and direction that the finger, stylus or other pointing device is moved is what triggers different functions. In a more preferred embodiment, the input device of this invention comprises a plurality of multifunctional input segments.

Preferably, the multifunctional input segment is selected from a key, a button, a portion of a touch screen, a portion of a touchpad or a portion of an electronic stylus.

The term “force of pressure exerted by a user on said multifunctional input segment” as used herein means how hard a multifunctional input segment is pressed or the distance such an input segment is moved. Typically pressure is exerted by a user's hand, particularly a finger, or by a device controlled by a user's hand, such as a stylus.

The way in which the force of pressure is detected according to this invention can be varied. In one embodiment, a pressure-sensitive device measures the force exerted on the multifunctional input segment. The pressure-sensitive device communicates the measured force to the computer in communication with said input device, which, in turn, translates the measurement into instructions to carry out the function corresponding to that force. Typically, a range of force is correlated with a function to allow for variances between users.

The pressure-sensitive device may be located underneath, integrated into or located on the surface of the multifunctional input segment. Alternatively, the pressure-sensitive device may be attached to a finger, or on the surface of, or integrated into a stylus or other device manipulated by the user to exert pressure on the multifunctional input segment.

In another embodiment, the force exerted on the multifunctional input segment is mechanically manifested by physically depressing the multifunctional input segment to a lower depth. The depth to which the multifunctional input segment is depressed is sensed by or communicated to the computer in communication with the multifunctional input segment or input device and is translated into instructions to carry out the function corresponding to that depth. In one aspect of this embodiment, the input segment may be in communication with a lever that moves in accordance with the segment depth.

In another embodiment, the force exerted on a multifunctional input segment is the force of pressure on a deformable material in communication with said multifunctional input segment. Alternatively, the multifunctional input segment itself comprises a deformable material. The deformable material may be as a liquid, a gel or a gas, and the force of pressure detected is the pressure of that liquid, gel or gas. In this embodiment, the liquid, gel or gas may be contained within a sealed compartment integrated into or in physical contact with the multifunctional input segment. Alternatively, the input device may comprise a layer of liquid, gel or gas in physical communication with the multifunctional input segment (and monofunctional input segments) components thereof. In this case, changes in pressure in local areas of such a layer of deformable material must be detectable.

In yet another embodiment, the force exerted on the multifunctional input segment is mechanically manifested by physically moving the multifunctional input segment in two or more different directions. This aspect is often associated with a multifunctional input segment that comprises a portion that is physically raised off of the surface of the input device and is capable of one dimensional movement, such as a wheel, or two-dimensional movement in a plane, such as a joystick, IBM Thinkpad® pointer, or trackball. The direction that the input segment is moved is sensed by or communicated to the computer in communication with the multifunctional input segment or input device and is translated into instructions to carry out the function corresponding to that direction. In this embodiment, the input device comprises multiple multifunctional input segments, each of which comprises a separate portion capable of one or two-dimensional movement in a plane.

In another embodiment, the force exerted on the multifunctional input segment is mechanically manifested by physically moving the multifunctional input segment in either two or more different directions and by depressing to different depths. For example, a wheel may be moved up or down or it may be depressed, each of which triggers a different function. Similarly a joystick-type input segment is capable of two-dimensional movement in a plane to trigger multiple functions and can be depressed to different depths to trigger other functions. Furthermore, at each depth, the input segment may still be capable of two-dimensional movement, providing the potential to produce numerous different functions via a combination of depth and planar movement.

In one embodiment, the multifunctional input segment provides feedback to the user in order to inform the user which function had or will be invoked. The feedback may be any one or more of visual feedback, audio feedback or haptic (e.g., tactile) feedback.

Visual feedback may be achieved by changing a visual output as the force of pressure on the multifunctional input segment changes. For example, when the output of a multifunctional input segment is one of several characters, the character corresponding to the force of pressure currently exerted on the multifunctional input segment will appear on a display in communication with the input device (either directly or indirectly through the computer) and change in real time as the force of pressure changes. In a preferred embodiment, all of the outputs controlled by a multifunctional input segment are indicated on a display when a force of pressure is exerted on that segment (e.g., in a menu) with the presently selected function somehow distinguished from the unselected functions (e.g., through bolding of the selected function and/or graying out of the unselected functions). In this embodiment, as the force of pressure on the multifunctional input segment changes, the display changes to highlight the newly selected function.

The display can be separate from the input device, such as a LCD or other video display. Alternatively, the display can be located on the input device itself, such as on a keyboard, mouse, touchpad or touchscreen in an area adjacent to the multifunctional input segment or even at the input segment itself.

Haptic feedback may be the result of the physical movement of the multifunctional input segment. For example, a LCD touchscreen may be manufactured with a thicker liquid crystal such that the user can actually feel changes in displacement of the liquid as greater pressures are exerted.

In another embodiment, the surface above or below a multifunctional input segment may be made of a deformable material, such as a gel, foam or soft rubber, which compresses as greater pressure is applied. It will be apparent that if the deformable material is above the multifunctional input segment it must not mask a visual indication of what functions that segment controls. Thus, the deformable material may be imprinted with such a visual indication. Alternatively, the deformable material may be see-through, such that an imprinted indication of function on the underlying input segment is visible.

In another embodiment, a multifunctional input segment capable of being depressed to different depth, such as a key, may catch at a ratchet or other such device, temporarily stopping at each depth corresponding to a different function. Invoking functions at lower depths would then require additional force of pressure to bypass such a temporary stop.

Haptic feedback can also be produced electronically in response to variations in force of pressure. Thumpers, solenoids, force feedback, vibrations, and shock are all examples of electronically produced haptic feedback that can be utilized in the invention. Technology for employing haptic feedback mechanisms in keyboards, mice, touchpads and other input devices are well-known in the art. See, for example, U.S. Pat. Nos. 6,906,697 and 6,864,877; and United States published applications 20050134562, 20040130526, 20030184574 and 20030174121, the disclosures of which are herein incorporated by reference. Moreover, different frequencies, patterns, quantities and intensities of haptic feedbacks may be employed to indicate the triggering of different functions through the multifunctional input segment. Haptic feedback is preferably used in conjunction with a multifunctional input segment that detects force of pressure without physically moving, deforming or compressing when increased force of pressure is applied.

Audio feedback can be in the form of audible clicks, beeps or other sounds. The quantity and nature of the sounds (tone, pitch, intensity) can be correlated with different functions that can be triggered by the multifunctional input segment. Alternatively, audio feedback can be in the form of electronically generated spoken words or characters corresponding to the function triggered or about to be triggered. Preferably, the audio feedback is in real time such that the user can alter the force of pressure on the multifunctional input segment if the audio feedback does not correspond to the desired function.

In a more preferred embodiment an input device comprises multiple multifunctional input segments. It is preferred that the individual segments be distinguishable from one another both visually and tactilely. In one preferred embodiment, the input device is a keypad. Each key on the keypad is preferably a multifunctional input segment capable of producing multiple characters. The keys themselves may be distinct, tactilely distinguishable buttons, such as on a keyboard, and have a display indicating some, if not all, the characters it is capable of outputting. The display may simply be printing on each key or a display capable of being backlit. Alternatively, the display can be a small LED, LCD or electronic ink display that is capable of changing in response to instructions generated from a computer in communication with the input device. The latter type of display is particularly useful where the keyboard is used for generating multilingual output.

If the individual segments are portions of a graphics tablet, touchscreen, touchpad or other input device that is a smooth planar device, it is preferred that the input device include means for tactilely separating the individual multifunctional input segments. The tactile separation means are in communication with the surface of the input device in a manner such that individual input segments may be distinguished by touch by the user. The separation means may be permanent or removable.

In one embodiment, the separation means are raised borders around the individual multifunctional input segments. The borders may be interrupted or uninterrupted (e.g., a complete raised square around a square multifunctional input segment or just the vertical borders on either side of that segment. In a preferred embodiment, the borders are present in a flexible, removable, grid. The edges of each cell in the grid are sufficiently raised to be tactilely detected. An individual cell in the grid corresponds to and overlays one multifunctional input segment.

Another means of tactilely distinguishing multifunctional input segments is through the use of bumps or other raised areas or a differently textured surface. The raised areas can be stationary or, in certain embodiments, may be rollers, such as trackballs or ball bearing-like structures. The raised area or differently textured surface may be on top of all or part of each individual multifunctional input segment. When completely covering an individual multifunctional segment, the raised area or differently textured surface is the tactile equivalent of keys that are used to orient the user's fingers on the segment. When covering only a portion of the multifunctional segment, the raised area or differently textured surface orients the user's finger to the center of that multifunctional input segments.

It is expected that the display indicating the some or all of the functions of the multifunctional input segment will be generated on the smooth planar input device. Thus, it is preferred that any raised area to be placed on top of the multifunctional input segment not obscure that display. This is preferably achieved by making the raised area from transparent materials.

A smooth planar input device may, alternatively, be made with permanent depressions to indicate the location of multifunctional input segments. In yet another embodiment, a smooth planar input device made of flexible or compressible material and is in communication with a matrix array of pins or solenoids that underlie the input segment. Each of the pins or solenoids is capable of a first, default position wherein it cannot be tactilely detected and a second position where it contacts the underside of the input segment such that it can be tactilely detected by a user placing a finger on the upper surface of that input segment. The array allows for a wide variety of different tactilely detectable features.

In one embodiment, the solenoid moves from the first position to the second position and back to first position in response to a force of pressure, generating a tactile thump felt by the user. The number of cycles or thumps can correspond to the function being invoked (i.e., the force of pressure being exerted). Alternatively the length of time the solenoid remains in the second position can vary according to the function being invoked.

In another example, pins defining the outer borders of the input segment can be in said first position. In addition, pins defining one or more of the multiple functions controlled by that input segment can be in said first position. The pins that are in said first position may change in response to the force of pressure placed on the segment, corresponding to the particular function that is being triggered by the force of pressure presently being applied. For example, a multifunctional input segment can produce the letter A, B, C or the number 2, depending upon the force of pressure applied. At a force of pressure that outputs an A, pins outlining the character A are in the first position, thus allowing the user to feel the letter A under his finger. When force of pressure is sufficiently increased to output the letter B, the pins alter position such that pins outlining the letter B are in the first position and the user feel the letter B under his finger, and so on. The use of pins or solenoids to form characters that can be tactilely detected by a user is described in United States patent publication 20050158695, the disclosure of which is herein incorporated by reference.

In another preferred embodiment, the input device is a computer mouse wherein the buttons and wheel, if present, are each multifunctional input segments. In this embodiment, the multiple functions controlled by each of the mouse buttons are preferably typical functions that can be singly programmed into buttons on an existing mouse. These include selecting items on a display, dragging, opening up context menus, jumping a cursor to specific locations within a program or operating system, minimizing and maximizing windows, opening and closing programs, double clicks, scrolling of windows, various controls related to a web browser (browse forward or backward one web page, reload page, stop loading page, open favorites, open history, go to a designated web page), cursor movement (i.e., page up/page down, up/down/left/right arrow), or running or recording a series of keystrokes. In certain embodiment, activation of the function selected from a multifunctional input segment may require an additional user action, such as moving the mouse at least a minimal distance, depressing another button present on the mouse, or applying pressure on the mouse itself.

In another embodiment, the entire mouse itself is a multifunctional input segment, wherein different amounts of force of pressure applied to a mouse sitting on a surface invoke different functions. In this embodiment, the bottom surface of the mouse or a portion thereof, comprises pressure detecting elements.

In yet another embodiment, the invention provides an input device in the shape of a typical computer mouse having a top surface that is a display and having a plurality of multifunctional input segments. The display indicates the location and some or all of the functions of each multifunctional input segment. The display may be a touch sensitive display. Alternatively, the multifunctional input segments may comprise a roller, a ball bearing or another tactilely detectable feature under or on top of the display. In some embodiments, the tactilely detectable feature may comprise means for detecting force of pressure. In other embodiments this feature functions only to providing haptic feedback, allowing the user to locate each multifunctional input segment by feel.

In one embodiment of the invention, the functions associated with each multifunctional input segment are user-defined. In this embodiment, the input device has a “setup” routine whereby the user can assign a function to a particular multifunctional input segment and a particular force of pressure. When an input device of this invention comprises a display that is in communication with a processor (which can be located in the input device or in the computer in communication with the input device), the display is capable of changing to reflect any user-defined changes.

In one preferred aspect of this embodiment, the input device is touchscreen comprising a plurality of multifunctional input segments, wherein each of said segments is indicated by a display of a key and each segment outputs one of a plurality characters in response to different forces of pressure, wherein the language of the characters outputted by each segment are user-defined and wherein the display of each key changes in response to the language defined by the user.

In one embodiment of the invention, the force of pressure required to invoke different functions is user-adjustable. In this embodiment, the input device has a “training mode” where the user is asked to apply different relative forces of pressure on the multifunctional input segment. The computer then correlates the detected forces with the triggering of the different functions controlled by the segment. For example, a multifunctional input segment is capable of outputting three different characters, a first character at soft pressure, a second character at medium pressure and a third character at hard pressure. In the training mode the user is asked to put soft pressure on the input segment at least once and preferably multiple times. The computer records the intensity of these forces and correlates the range of forces with the output of the first character. This process is repeated for medium pressure and hard pressure.

The user-adjustability is particularly important both to tailor the proper output to the individual user and to individual fingers of a user. The actual pressure corresponding to soft pressure exerted by an index finger may be very different form that corresponding to soft pressure from a pinkie. There also may be differences between the right and left hands of the individual. By allowing the force of pressure necessary to trigger the different functions of each multifunctional input segment to be separately adjustable, compensation for all of these variations can be made and the input device made less prone to unintended triggering of functions and therefore more “user friendly.”

In another embodiment, the size of the multifunctional input segments is user-adjustable. This is preferably achieved when the input device is a touch screen, touch pad or graphics tablet with multifunctional input segments representing a keyboard or keypad. Again, the input device has a training mode where size adjustment is carried out. The user is asked to place his hand or hands on the default keypad or keyboard displayed on the input device. The user is then asked to touch a specific input segment once or preferably multiple times. The computer then maps the coordinates of the touches and adjusts the size of the segment to encompass each of the touch coordinates. This is repeated for each input segment.

The adjustability of the size of the input segments is useful in compensating for variation in hand and finger size between users. Once adjusted, the input device is less prone to unintended triggering of functions and therefore more “user friendly.”

In yet another embodiment, the haptic feedback in response to the triggering of functions is user-controllable. This allows the user to turn off the haptic feedback, or to adjust its intensity, duration, and pattern for each function of a multifunctional input segment.

In one preferred embodiment, the choice of function in a multifunctional input segment through force of pressure requires confirmation before that function is carried out (before final output is produced). This is advantageous in that it allows the user to alter or negate the chosen function quickly and without having to completely undo the function.

Confirmation may be achieved through the expiration of a time period, the releasing of pressure from the segment, or the use of a second key or switch.

The expiration of a time period is achieved simply by applying a force of pressure corresponding to a function of a multifunctional input segment for a sufficient period of time. Preferably that period of time is less than about one second and more preferably between 1/10th of a second and one second. In embodiments employing the expiration of a time period to trigger a chosen function, the time period may be also be user-adjustable.

The releasing of pressure to cause the chosen function to output requires the user to lift their finger or stylus off of the multifunctional input segment after applying the desired force of pressure. The releasing off of the segment triggers the selected output.

When a second key or switch causes the chosen function to be outputted, it is preferably located for easy access to the user and allows the user to maintain force of pressure on the multifunctional input segment without strain. In one preferred embodiment, such a second key is controlled by the user's thumb. An alternative to a second key for activation of the function is a footpedal or foot-controlled switch.

The different outputted functions that may be controlled from a multifunctional input segment include, but are not limited to, different characters (numbers, letters, symbols, punctuation marks), different predicted words in conjunction with an autofill function, different phonemes (such as used in stenography), different font styles, different font sizes, different font types, text color, different repeat rate, different menu choices (i.e., scrolling through a menu, optionally while displaying the result of the currently selected menu item), and capitalization and other case changes or combinations of any of the above. More preferably, the different outputted functions of a multifunctional input segment correspond to different characters, font size or font style. Most preferably, the different outputted functions of a multifunctional input segment correspond to different characters.

In an alternate embodiment, the invention provides an input device with multiple input segments, wherein each input segment has at least two different states corresponding to the force of pressure exerted by a user on said segment and wherein output is produced dependent upon the combination of segments upon which force of pressure is applied and upon the amount of force of pressure applied on each segment. The output of each combination produced on such a device is preferably a character, a phoneme, a word, or a phrase. For example, a five key (designated “A”, “B”, “C”, “D” and “E”) input device wherein each key has two states of response to force of pressure (designated “1” and “2” for the purposes of description) in addition to an unpressed state (designated “0”) provides 35-1 (when each of the 5 keys is in the 0 state no output is produced) or 242 possible single and multiple key combinations.

In a preferred embodiment, the combinations are limited to one and two key combinations because of practicality and ease of user control. In this preferred embodiment, there are 10 single key combinations (“1” or “2” for each of the five keys) and 40 two key combinations (four combined states—“1-1”, “1-2”, “2-1” and “2-2”—for any two key set; and 10 possible two key sets—“AB”, “AC”, “AD”, “AE”, “BC”, “BD”, “BE”, “CD”, “CE”, and “DE”) allowing for 50 different outputs. This is sufficient to produce all 26 letters, all 10 digits and 14 other characters. Such an input device should be capable of producing any desired text with a single hand.

In another example an input device with 8 multifunctional input keys and three possible depressed states for each key in addition to an unpressed state can produce 48-1 or 65,535 different combinations. If each combination resulted in the output of a different word, the input device would be capable of producing more than enough outputs to cover an average educated person's entire vocabulary. In a preferred embodiment, certain combinations of keys would produce words corresponding to specific parts of speech (e.g., nouns, verbs, adjectives) to make the use of the input device easier to learn.

A plurality of multifunctional input segments on the input devices of this invention may be arrayed in various configurations. The choice of configuration is typically based upon the function of the input device. In a more preferred embodiment, the input device is a mobile phone keypad comprising 12 multifunctional input segments arrayed in a typical 4×3 grid. Other arrays, including circular arrays, linear arrays and other grid arrays can also be employed.

The input device of the invention may itself comprise two separate parts. In one embodiment, the input device comprises two parts, each comprising four or five multifunctional input segments. The device is designed to be held in a users hands; one part in each hand. This device is preferably used to produce characters and symbols to output text.

The input devices of the present invention can be used in numerous product applications including, but not limited to, mobile phones, desktop computers, public computer terminals such as ATM machines and internet kiosks, vehicle computers, PDAs, portable digital music playback devices, in-home stereos, car stereos, musical instrument controllers, tablet or notebook computers, appliance controllers, robot controls, game or toy controllers, hand-held electronic games, home or building control systems, flight controllers, arcade games, bike gadgets, motorcycles, ATVs, snowmobiles, medical equipment, research equipment, fish finders, GPS devices, cash registers, customer ordering devices, internet terminals, devices for impaired persons, scuba gear or surgery control devices.

Each of the embodiments for multifunctional input segments and input devices that comprise them described above are also applicable to monofunctional input segments. Although embodiments relating to monofunctional input segments are less preferred, to the extent that they are novel and unobvious, they are part of the present invention.

### BRIEF DESCRIPTION OF THE DRAWINGS

FIG. 1 depicts multiple side views of a multifunctional input segment of this invention.

FIG. 2 depicts multiple top views of a portion of an input device of this invention comprising a plurality of multifunctional input segments.

FIG. 3 depicts a laptop computer of this invention comprising a plurality of multifunctional input segments.

FIG. 4 depicts a cellular phone of this invention comprising a plurality of multifunctional input segments.

FIG. 5 depicts the relationship between depth of depression and force required for a multifunctional key of this invention.

FIG. 6 depicts a mouse of this invention comprising a plurality of multifunctional input segments.

FIG. 7, panels A and B, depict character maps of a keypad of this invention comprising twelve multifunctional keys.

FIG. 8 depicts a character map of a qwerty keyboard of this invention wherein each key is a multifunctional input segment.

FIG. 9 depicts a character map of a mulitfunctional input segment-containing input device of this invention capable of all functions producible on a standard 101 key computer keyboard.

FIG. 10 depicts the functional groupings for each multifunctional input segment present in an input device of this invention.

FIG. 11 depicts a character map of a 12 multifunctional input segment-containing input device of this invention.

### DETAILED DESCRIPTION OF THE INVENTION

Certain embodiments of the present invention are described below. It is, however, expressly noted that the present invention is not limited to these embodiments, but rather the intention is that additions and modifications to what is expressly described herein also are included within the scope of the invention. Moreover, it is to be understood that the features of the various embodiments described herein are not mutually exclusive and can exist in various combinations and permutations, even if such combinations or permutations are not expressly made herein, without departing from the spirit and scope of the invention.

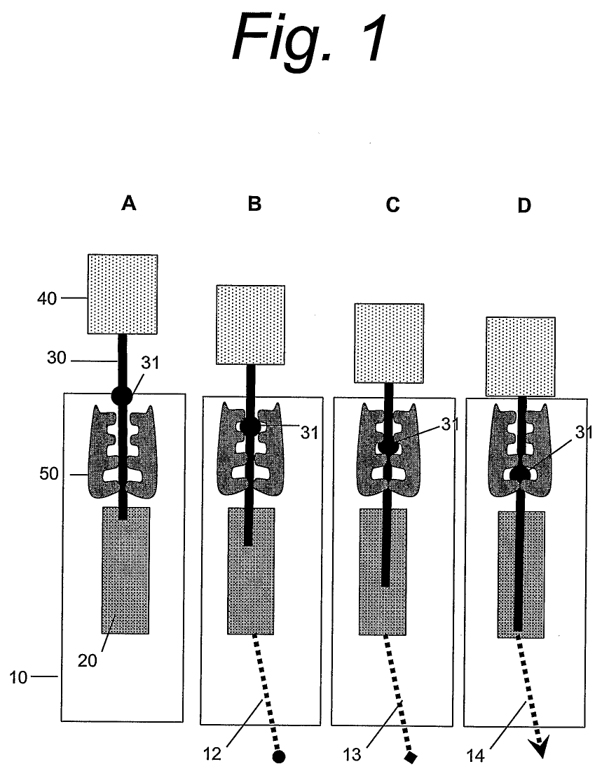

FIG. 1 depicts a cutaway side view of a multifunctional key 40 in one particular multifunctional input segment 10 of this invention. The key 40 is mounted on a plunger 30 which is in communication with a depth sensing receptacle 20. The depth sensing receptacle detects how far the plunger has been depressed and transfers that information to a computer (not shown) which translates the depth data to the corresponding function which is then outputted, typically on a display (not shown). The plunger 30 comprises an expanded portion 31 that interacts with a series of catches 50 to provide tactile feedback to the user as to what depth the key has been depressed and thus which function is being invoked.

In panel A, no pressure has been applied to the key 40 and the expanded portion of the plunger 31 is not in contact with the catches 50. In panel B, the key has been depressed to a level corresponding to the first function. The expanded portion 31 of the plunger has entered the first catch and the depth of the plunger causes the depth sensing detector to output a first signal 12 to a computer. In panel C, the key has been depressed to a level corresponding to the second function. The expanded portion 31 of the plunger has entered the second catch, which provides the user with the haptic feedback of two clicks as the expanded portion of the plunger stops in the first catch and then the second. The depth of the plunger causes the depth sensing detector to output a second signal 13 to a computer. In panel D, the key has been depressed to a level corresponding to the third function, providing a third click felt by the user. The expanded portion 31 of the plunger has entered the third catch and the depth of the plunger causes the depth sensing detector to output a third signal 14 to a computer.

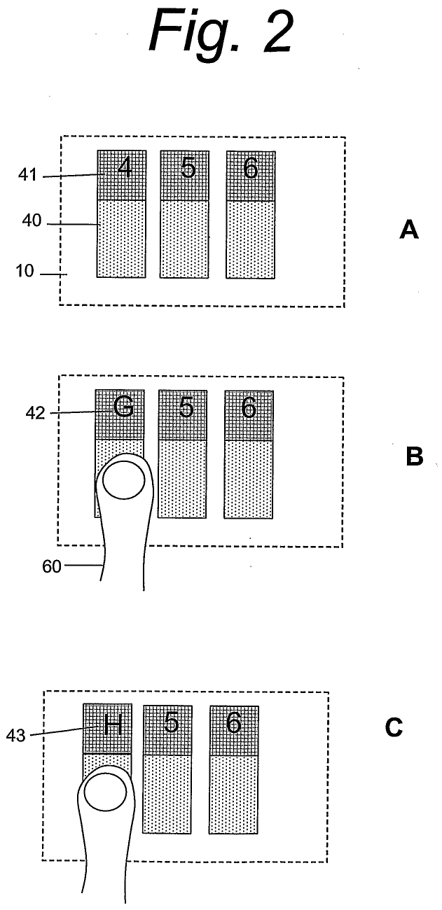

FIG. 2 depicts a input device 10 comprising input segments 40 and a display 41 adjacent each input segment that changes according to the force of pressure on the segment, displaying the output to be triggered by that force of pressure. In panel A, the first input segment 40 is capable of outputting the number 4, the letter G and the letter H. The display 41 shows the number 4, when no pressure is being applied to that segment indicating that this is the first function that will be invoked by applying force of pressure on input segment 40. In panel B, the user has increased the force of pressure on the segment with a finger 60 to invoke the output of the letter G, the corresponding output is displayed on the display 42 associated with the segment. In panel C, the user has further increased the force of pressure on the segment with a finger 60 to invoke the output of the letter H. Again, a corresponding output is displayed on the display 43 associated with the segment.

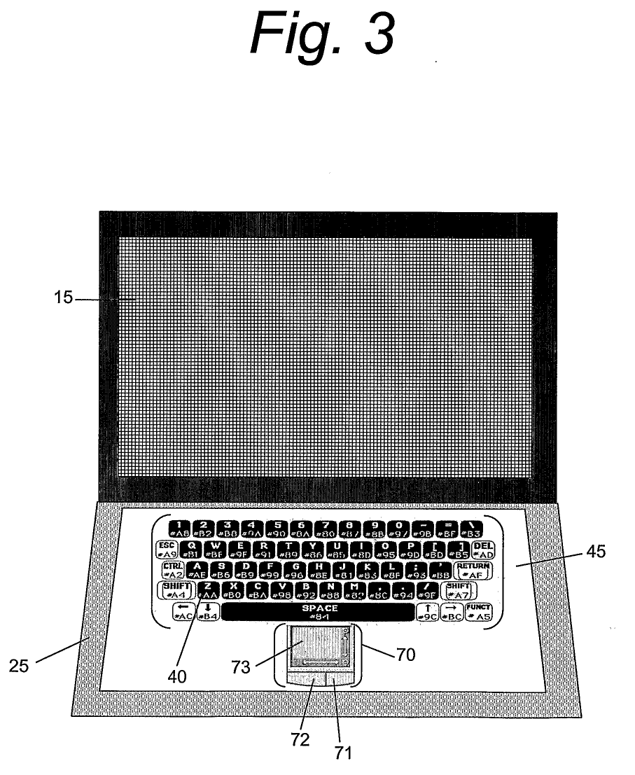

FIG. 3 is a laptop computer comprising a display 15 and a touch-sensitive input device 25. The touch-sensitive input device is also a display showing an image of a keyboard 45 and an image of a mouse touchpad 70. The keyboard image 45 comprises a plurality of multifunctional input segments that are displayed as keys 40. The image of the touchpad 70 comprises two displayed buttons 71 and 72 and a touchpad segment 73. Each of the key images 40, the mouse buttons 71 and 72, and the touchpad 73 is a multifunctional segment capable of two or more outputs depending on the force of pressure applied to that segment. A pressure-sensing device (not shown) underlies each of the multifunctional segments and transmits the force of pressure to a cpu (not shown), which translates that information into output on the display 15.

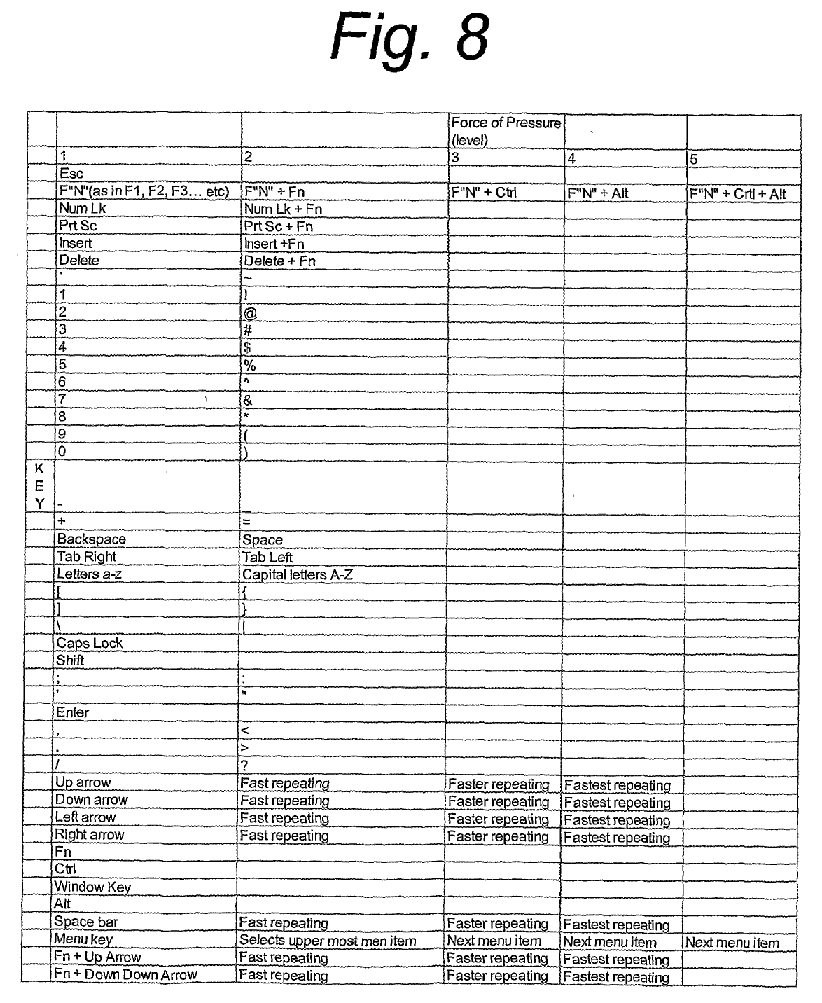

A character map showing the various functions for each of the key-image multifunctional input segments of the input device of FIG. 3 and the level of force of pressure required to invoke that function is shown in FIG. 8.

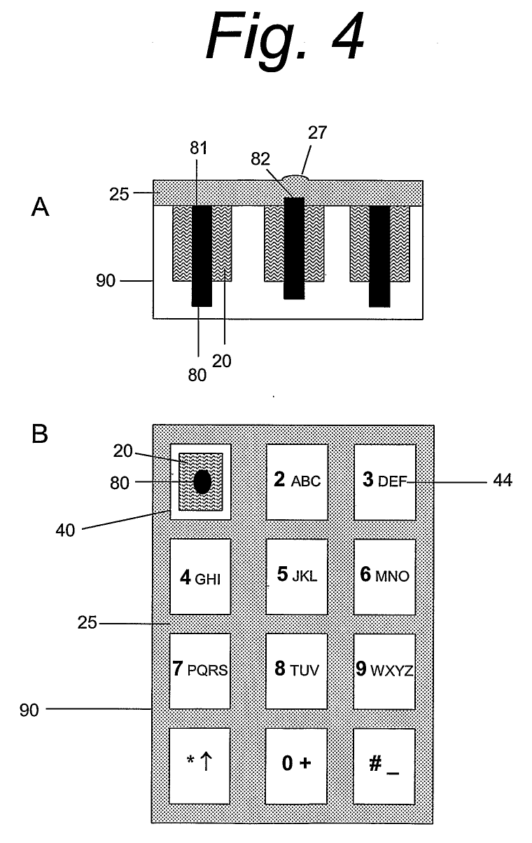

FIG. 4 depicts an input device 90 comprising a touch screen having multifunctional segments corresponding to the keys on a phone. Panel A is a cutaway side view of the phone. The touch screen 25 is underlayed by a series of pressure sensors 20 that surround a central solenoid 80. The solenoid 80 provides haptic feedback to the user corresponding the force of pressure detected by the pressure sensor 20. The touch screen 25 is sufficiently deformable (such as a LCD) for the movement of the solenoid 80 to be felt by the user's finger. The solenoid 80 has a first position 81 where it does not cause any deformity in the touch screen 25. When the pressure sensor 20 detects a force of pressure corresponding to the triggering of the first function of the multifunctional segment it transmits a signal to the solenoid causing it to move for a period of time to a second position 82 where it presses into the touch screen 25 causing a slight deformity 27 that is detectable by the user and then return to the first position 81. Forces of pressure corresponding to second, third or fourth functions cause the pressure sensor 20 to transmit a signal to the solenoid to cycle from the first position to the second position and back to the first position two, three or four times, respectively. Thus, the user feels one, two, three or four thumps underneath his finger corresponding to the function to be outputted.

Panel B is a top view of the input device 90. The touch screen 25 displays multifunctional segments corresponding to keys 40 with a display 44 of the functions that can be outputted by each segment. The touch screen surface has been peeled away on the upper left input segment to show the orientation of the touch sensor 20 surrounding the central solenoid 80.

It should be understood that the single solenoid 80 could be replaced by a series of pins or other movable devices to achieve the same purpose. Moreover, the pattern of movement of the solenoid 80 from a first position to a second position and back to the first position can be altered in duration, force and different patterns to provide the user with haptic differentiation of the functions being triggered

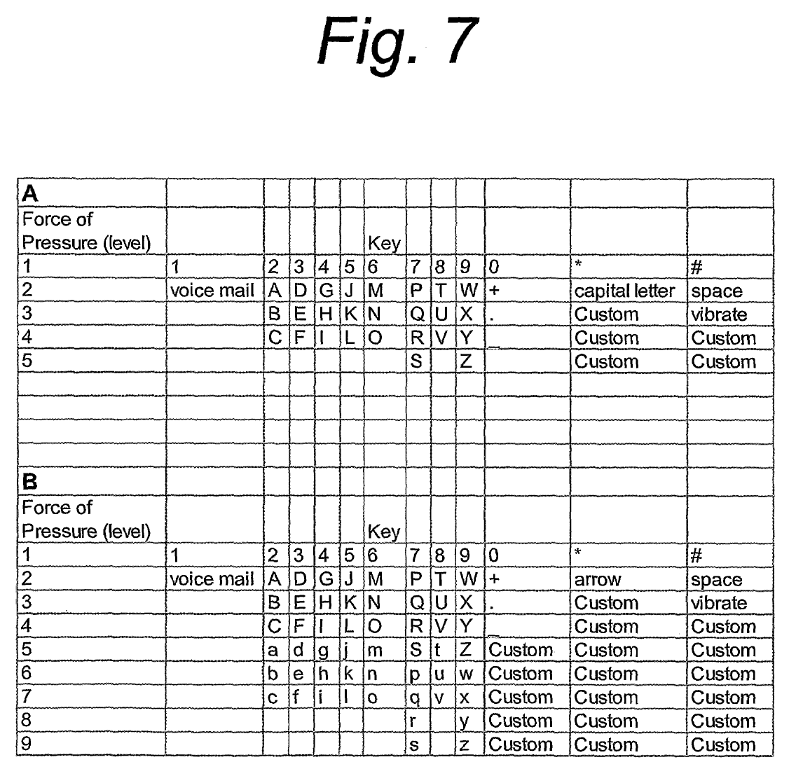

A character map showing the various functions for each of the keys of the input device of FIG. 4 and the level of force of pressure required to invoke that function is shown in FIG. 7.

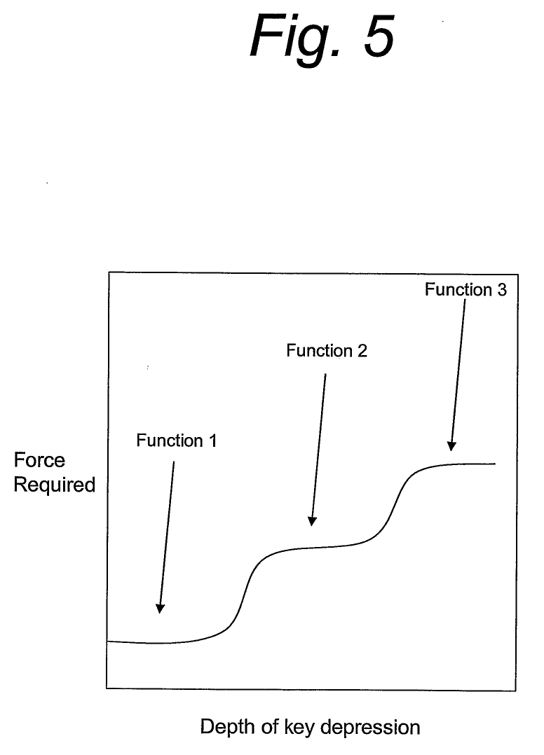

FIG. 5 is a graph of depth of key depression versus force required for a multifunctional keyboard of this invention. Additional force is required to depress the key to pass the interface of two functions. That additional force provides haptic feedback to the user informing him that the next function has been triggered. That additional force applied at the interface may also be accompanied by additional haptic feedback, such as a click, to further alert the user that the next function has been triggered.

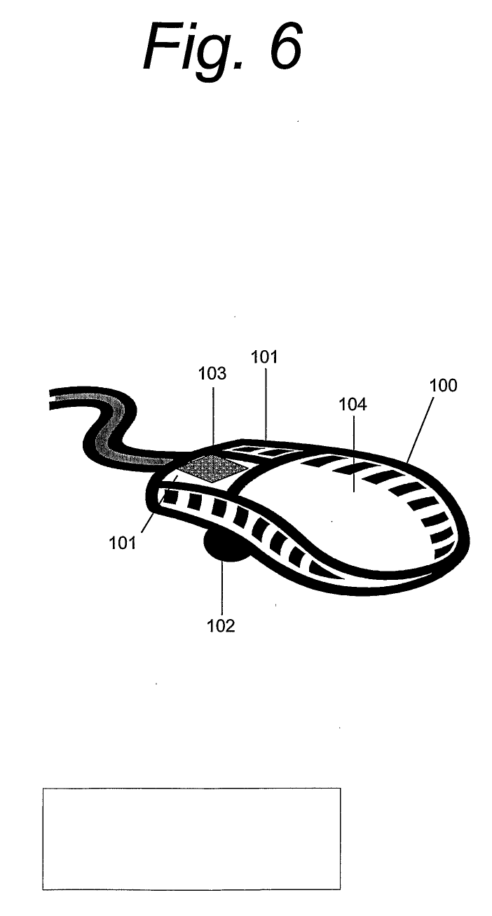

FIG. 6 depicts a mouse 100 of the present invention. The mouse 100 comprises two multifunctional buttons 101 and a multifunctional roller 102. The buttons are underplayed by pressure sensors (not shown) and the roller is connected to another pressure sensor (not shown). The various functions controlled by the roller 102 are triggered by the force of pressure exerted downward on the mouse 100, such as by the palm of a user. The mouse 100 also comprises a display 103 that shows the function being triggered by either button or the roller. The location of the display 103 is shown on one of the buttons, but could also be on both buttons, the lower part of the mouse 104 or any combination thereof.

It should also be understood that the roller 102 could be replaced by any sort of surface that is in communication with pressure sensors that can detect force of pressure being exerted downwardly on the mouse. Thus, an optical mouse can combine the optical surface on the underside of the mouse with a pressure sensor that can detect downward pressure on the mouse without interfering with the optical detection of movement of the mouse on a plane.

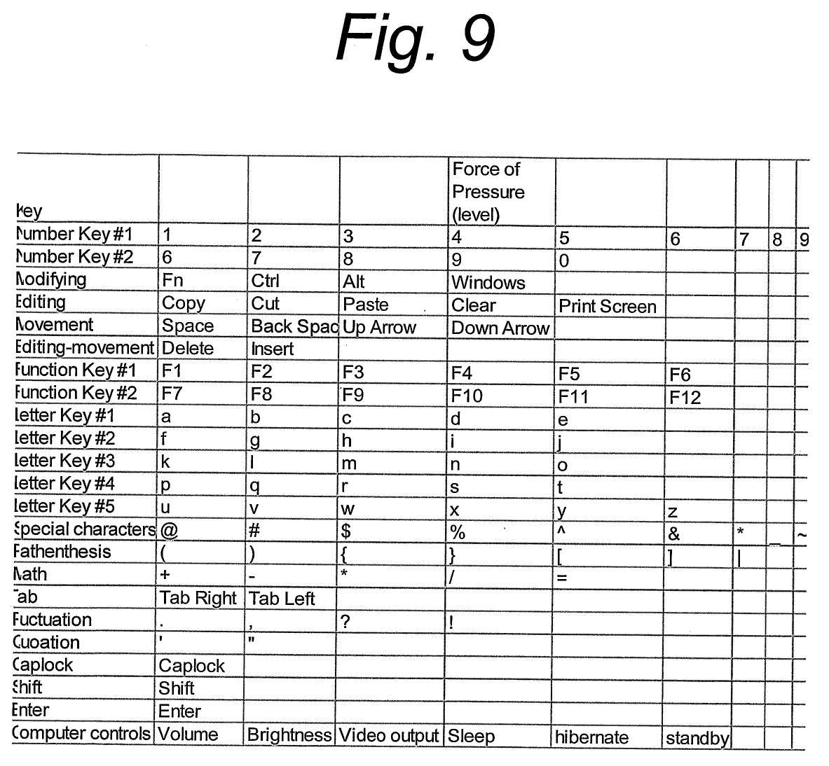

Other input devices of this invention may have a reduced number of input segments and a greater number of functions associated with each multifunctional input segment. FIG. 9 demonstrates that 23 multiple input segments in a device is sufficient to perform all of the functions typically performed by a standard 101 or greater key keyboard. Each of the multifunctional segments in this embodiment controls functions that are logically grouped together.

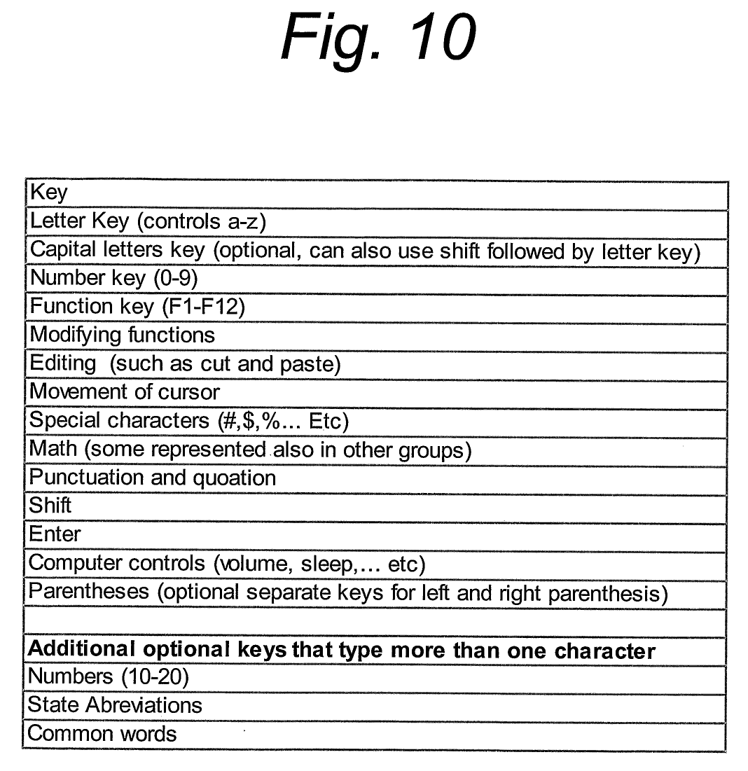

FIG. 10 demonstrates that by increasing the number of functions associated with each multifunctional input segment all of the functions typically performed by a standard 101 or greater key keyboard can be controlled by 13 to 15 keys. Again, each of the multifunctional segments in this embodiment controls functions that are logically grouped together.

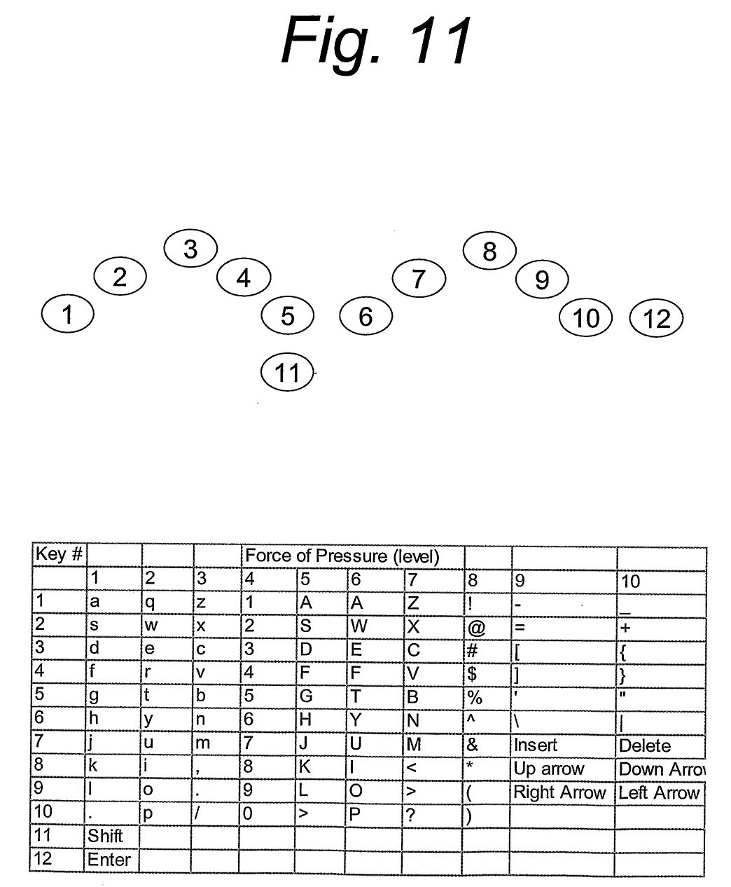

FIG. 11 show a 12-key keyboard that produces all alphanumeric characters (including capital letters) and frequently used symbols and punctuation marks; and the associated character map. Keys 1 through 10, corresponding to each finger of two hands, are multifunctional and between them produce all of the characters and symbols. Thus, the outputting of any text is controlled without ever having to change the position of a finger. The other two keys correspond to a space bar and an Enter key and are controlled by the left thumb and the right pinky, respectively.

What is claimed is:

1. An input device in communication with a computer, said input device comprising a multifunctional input segment, wherein force of pressure exerted on said multifunctional input segment determines which function is outputted by said computer.

2. The input device according to claim 1, selected from a computer keyboard, a chorded keyboard, a keypad, a key-based control panel, a computer mouse, a trackball, a touchpad, a trackpad, a joystick, a pointing stick, a stylus, a light pen, a light gun, a cyberglove, a graphics tablet, a digitizing tablet, a touch screen, a gamepad, a joypad, a paddle, a floor pad, a Power Pad; an array of control buttons on an electronic device, a control panel in a vehicle, a stereo control panel, a radar detectors, a GPS device or a control panel in a flight controller.

3. The input device according to claim 2, selected from a computer keyboard, a touchpad, a touch screen or a mouse.

4. The input device according to any one of claims 1 to 3, wherein said multifunctional input segment is selected from a key, a button, a portion of a touch-sensitive device; a portion of an electronic stylus; a joystick, a joypad, a wheel, a finger of a cyberglove; or a finger, stylus or other pointing device used in conjunction with a video recorder that detects and distinguishes movement or with a motion detector.

5. The input device according to claim 4, wherein said multifunctional input segment is selected from a key, a button, a portion of a touch screen, a portion of a touchpad or a portion of an electronic stylus.

6. The input device according to claim 1, wherein said computer is selected from a laptop computer, a desktop computer, a workstation, a cell phone, PDA or a device that is a combination of one or more of the foregoing.

7. The input device according to claim 1, wherein the force of pressure exerted on the multifunctional input segment is detected by a pressure-sensing device in communication with said multifunctional input segment.

8. The input device according to claim 1, wherein the force of pressure exerted on the multifunctional input segment is mechanically manifested by physically depressing the multifunctional input segment to different depths and said input device additionally comprises a sensor that detects the depth to which said multifunctional input segment is depressed.

9. The input device according to claim 1, wherein the multifunctional segment comprises or is in communications with a deformable material and wherein the force of pressure is measured by the pressure of said deformable material.

10. The input device according to claim 1, comprising a plurality of multifunctional input segments, and wherein the force of pressure exerted on each multifunctional input segment is mechanically manifested by physically moving the multifunctional input segment in two or more different directions in a plane.

11. The input device according to claim 8, wherein the force of pressure exerted on said multifunctional input segment is further mechanically manifested by physically moving the multifunctional input segment in two or more different directions at each depth of depression.

12. The input device according to claim 1, wherein said device provides feedback indicative of the function being invoked by the force of pressure applied to the multifunctional input segment.

13. The input device according to claim 12 wherein said feedback is selected from audio feedback, visual feedback or haptic feedback.

14. The input device according to claim 13 wherein said feedback is haptic feedback.

15. The input device according to claim 14 wherein said haptic feedback is controlled by a solenoid in communication with said multifunctional input segment, said solenoid having a first position that is not detectable by a user contacting said multifunctional input segment, and a second position that is detectably by a user contacting said multifunctional input segment, said solenoid completing at least one cycle of moving from said first position to said second position and back to said first position in response to force of pressure exerted on said multifunctional input segment.

16. The input device according to claim 15, further comprising a pressure-sensing device in communication with said multifunctional input segment, wherein said pressure-sensing device detects the force of pressure exerted on the multifunctional input segment.

17. The input device according to claim 13 wherein said feedback is visual feedback, wherein all of the functions controlled by a multifunctional input segment are displayed on a display in communication with said input device when a force of pressure is exerted on said multifunctional input segment, and wherein the currently selected function is distinguishable from the non-selected functions on said display.

18. The input device according to claim 1 comprising a plurality of multifunctional input segments, wherein each of said multifunctional input segments is distinguishable from one another visually or tactilely.

19. The input device according to claim 18, wherein said input device can produce all alphanumeric characters in a language.

20. The input device according to claim 19, wherein said plurality of multifunctional input segments comprise keys on a keyboard.

21. The input device according to claim 19, wherein said plurality of multifunctional input segments comprise portions of a touch screen or a touch pad, and wherein said input device further comprises a pressure-sensing device in communication with each multifunctional input segment, wherein said pressure-sensing device detects the force of pressure exerted on the multifunctional input segment in which it is in communication.

22. The input device according to claim 3, wherein said input device is a mouse comprising a multifunctional input segment on the underside of said, wherein the force of pressure is a downward pressure exerted by a user on the mouse.

23. The input device according to claim 22, further comprising two buttons, each of which is a multifunctional input segment.

24. The input device according to claim 23, further comprising a wheel, wherein said wheel is a multifunctional input segment, wherein the force of pressure exerted on said wheel is selected from forward rotation of said wheel, backward rotation of said wheel, downward pressure exerted on said wheel, or a combination of the foregoing.

25. The input device according to claim 18, wherein each multifunctional input segment is in communication with or comprises a display that defines the location of said multifunctional input segment and the functions controlled by said multifunctional input segment.

26. The input device according to claim 25, wherein the display of each multifunctional input segment is user-adjustable.

27. The input device according to claim 26, wherein the functions controlled by a multifunctional input segment is user-adjustable.

28. The input device according to claim 18, wherein said plurality of multifunctional input segments is configured as a qwerty keyboard.

29. The input device according to claim 18, wherein said plurality of multifunctional input segments is configured in a 4×3 grid.

30. The input device according to claim 1, wherein the force of pressure required to invoke a function of said multifunctional input device is user-adjustable.

31. An input device in communication with a computer and comprising a plurality of input segments, wherein each input segment has at least two different states corresponding to a force of pressure exerted by a user on said segment, wherein the function produced by said input device is dependent upon the force of pressure exerted on each of said plurality of input segments.

32. The input device according to claim 31, wherein said device comprises five input segments, each of which is capable of two different states corresponding to a force of pressure exerted on said segment, wherein the functions produced by said input device is the output of all alphanumeric characters.

33. A system comprising a computer, an input device and a display, wherein:
a. said computer is in communication with said input device and said display;
b. said input device comprises a multifunctional input segment, wherein force of pressure exerted on said multifunctional input segment determines which function is outputted by said computer; and
c. at least one of said functions is outputted onto said display.

34. The system according to claim 33, wherein said input device comprises a plurality of multifunctional input segments; and said input device controls said computer to output all alphanumeric characters in a language, each of which is outputted onto the display.
